(19) United States
(12) Patent Application Publication
(10) Pub. No.: US 2014/0141840 A1
(43) Pub. Date: May 22, 2014

(54) MOBILE ELECTRONIC DISPLAY

(71) Applicant: Paulo Jorge Caldas Pereira, JR., San Rafael, CA (US)

(72) Inventor: Paulo Jorge Caldas Pereira, JR., San Rafael, CA (US)

(21) Appl. No.: 13/682,253

(22) Filed: Nov. 20, 2012

(51) Int. Cl. H04W 88/04

(52) U.S. Cl. CPC H04W 88/04
USPC 455/566

(57) ABSTRACT

A mobile electronic display configured to display content, such as Web social media content, as selected by a portable electronic device, such as a smartphone or tablet.

### BACKGROUND OF THE INVENTION

1. Field of the Invention

The present invention relates generally to a mobile electronic display, and more particularly to an electronic display for displaying content as directed by a portable electronic device.

2. Description of the Related Art

Electronic signs and displays are known that can be updated by a computer. For example, U.S. Patent Pub. No. 2008/0284566, entitled Location Based Electronic Sign System, discloses a system for determining the proximity of an electronic display to an object, and then displaying information related to the object on the electronic sign.

Also, systems are known for dynamically updating mobile advertising displays, based on vehicle location, as disclosed by U.S. Patent Pub. No. 2002/0097193, entitled System and Method to Increase the Efficiency of Outdoor Advertising.

### SUMMARY OF THE INVENTION

A mobile electronic display configured to display content, such as Web social media content, as selected by a portable electronic device, such as a smartphone or tablet.

According to one embodiment, the present invention is a system for displaying digital content, the system comprising an electronic display, the electronic display comprising a message display area, a unique identification code; and a data communications unit, and a portable electronic device, the portable electronic device comprising at least one data communications unit, and a software application to communicate with the electronic display and to send messages to the electronic display. The data communications unit is preferably a wireless communications unit, such as a mobile data network communications unit. The system may further comprise an accelerometer and timer unit to activate the display when motion is detected and to turn off the display after a period of no detected motion. The digital display may include a unique registration number, wherein the portable electronic device and the electronic display are associated via the unique registration number.

According to a preferred embodiment, the portable electronic device is configured to send updates from social media accounts to the electronic display. In addition, messages may be sent to the user of the portable electronic device by use of the unique identification number displayed on the electronic display.

The portable electronic device may further comprise a first data communications unit for accessing a data network, and a second communications unit for communicating with the electronic display unit.

According to another embodiment of the present invention, a method for displaying messages on a display comprises associating a portable electronic device with an electronic display, accessing data for display from a web site, selecting data for display on the electronic display, sending the data for display from the portable electronic device to the electronic display, and displaying the data on the electronic display. A unique identification code may be displayed on the display.

The method may further include receiving notifications of messages sent to the unique identification code. The portable electronic device may be associated with the electronic display comprises using the unique registration number associated with the electronic display. The data for display from a web site may comprise accessing a user's social media accounts.

In another aspect, the present invention comprises a software application for a portable electronic device to control an electronic display, the software application including processor executable code for associating the portable electronic device with the electronic display, accessing data for display from a web site; selecting data for display on the electronic display, and sending the data for display from the portable electronic device to the electronic display. The software application may further comprise executable code for receiving notifications of messages sent to a unique identification code associated with the electronic display.

### BRIEF DESCRIPTION OF THE DRAWINGS

The present invention will be readily understood by the following detailed description in conjunction with the accompanying drawings, wherein like reference numerals designate like structural elements, and in which:

FIG. 1 illustrates a display system according to one embodiment of the present invention;

FIG. 2A illustrates a front view of an embodiment of the electronic display according to a preferred embodiment of the present invention;

FIG. 2B illustrates a rear view of an embodiment of the electronic display according to a preferred embodiment of the present invention;

FIG. 3 is a flow diagram illustrating the operation of the system according to one embodiment of the present invention;

FIG. 4 illustrates an exemplary set of screens for downloading and configuring a smartphone app for use with the present invention; and

FIG. 5 illustrates an exemplary set of screens for posting messages and seeing notifications on a smartphone app for use with the present invention.

### DETAILED DESCRIPTION OF THE INVENTION

The following description is provided to enable any person skilled in the art to make and use the invention and sets forth the best modes contemplated by the inventor for carrying out the invention. Various modifications, however, will remain readily apparent to those skilled in the art. Any and all such modifications, equivalents and alternatives are intended to fall within the spirit and scope of the present invention.

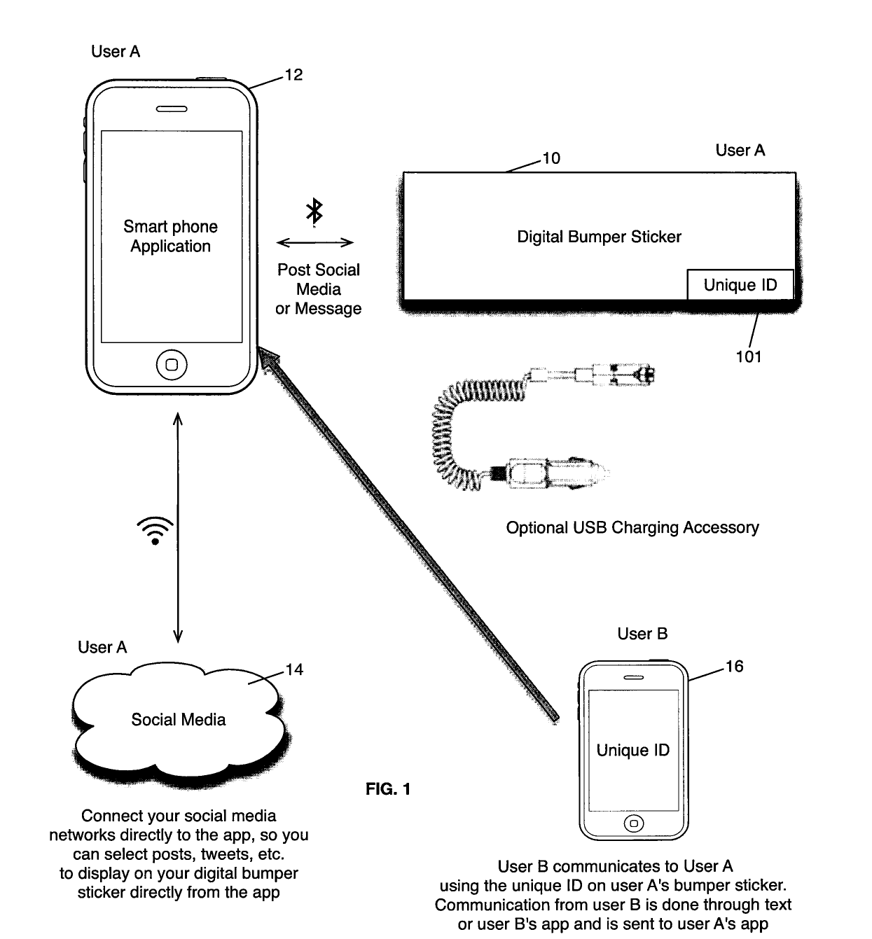

As shown in FIG. 1, a portable electronic display device according to a preferred embodiment of the present invention may be configured as a “digital bumper sticker” 10. The digital bumper sticker 10 is preferably an LCD display configured to mount inside a vehicle at a rear or side window. The digital bumper sticker 10 can be any size and shape, but is preferably rectangular and sized somewhat larger than a typical bumper sticker. The digital bumper sticker 10 preferably includes wireless communication functionality, such as Bluetooth or Wi-Fi, in order to communicate with a portables electronic device 12, such as a smartphone, tablet or laptop. The digital bumper sticker 10 also preferably includes a unique identification code 101 displayed as part of the display 10.

In one embodiment, the digital bumper sticker includes cellular or similar wide area wireless connectivity and can connect to the Internet directly. In such an embodiment, the digital bumper sticker may include, for example, a SIM card to access a wireless network carrier.

In a preferred application of the present invention, a user A updates a displayed message on the digital bumper sticker 10 by connecting to, for example, a social media website 14, and selecting any posts, tweets, photos, etc. to be displayed. An application or “app” running on the portable electronic device 12 takes the user selected content and transfers it to the digital bumper sticker 10.

The user selected content is thus displayed on the digital bumper sticker 10. In addition, other users, such as user B 16, can communicate back to user A by using the unique identification code 101 displayed on the digital bumper sticker 10. For example, user B 16 could send a text message, or utilize a special app designed to send a message to the unique identification code 101.

Preferably user A registers the unique identification code 101 to associate the unique identification code with user A′s portable electronic device 12. For example, a user could access a web server and create a user profile to associate the unique identification code 101 with the user's telephone number and/or email address.

The digital bumper sticker 10 is preferably solar and/or battery powered in order to avoid having to run power lines to the device. However, it could be powered by a standard car USB charger. Also, instead of a wireless data connection, the digital bumper sticker could have a physical wired connection to the portable electronic device 12.

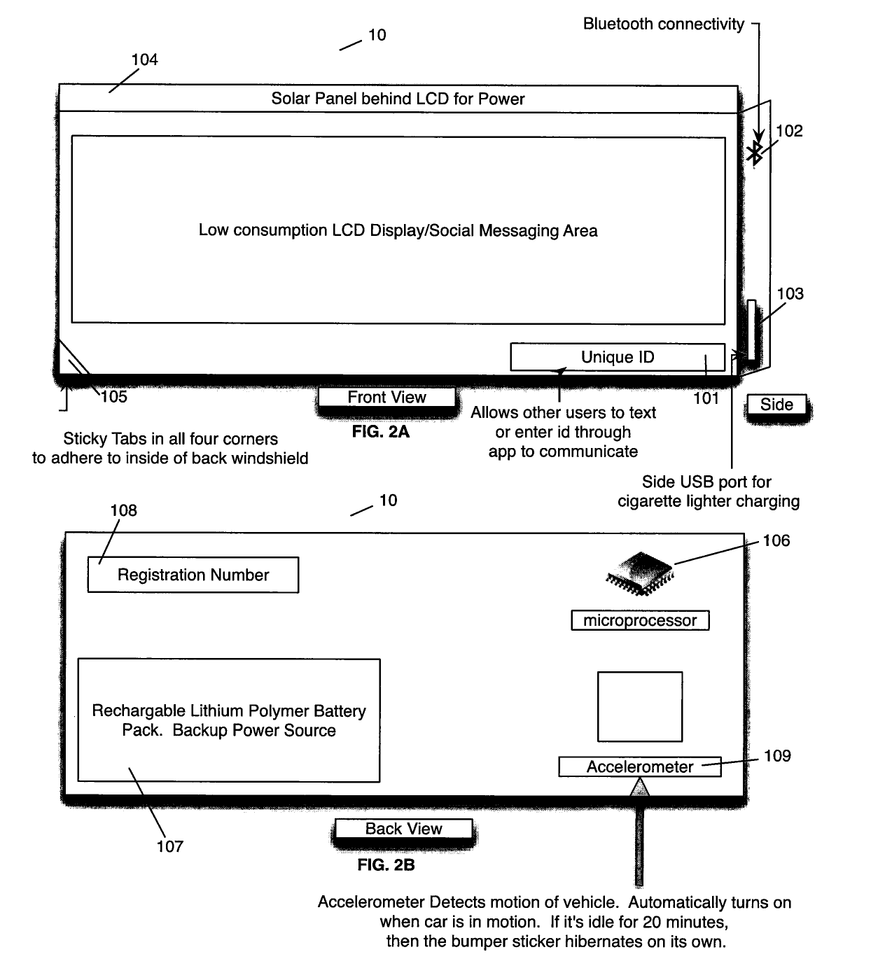

A preferred embodiment of the digital bumper sticker 10 is shown in greater detail in FIG. 2. FIG. 2A shows the front of the digital bumper sticker 10. As described above, the digital bumper sticker 10 includes a Bluetooth radio 102, a USB charging port 103, and a solar panel 104 for charging the battery in the device. In addition, the digital bumper sticker may include “sticky tabs” 105 on the four corners to adhere the display to a vehicle window.

FIG. 2B illustrates the back of the digital bumper sticker 10, and further includes a graphical representation of the internal components of the device. The digital bumper sticker 10 includes standard electronic functions for receiving, processing and displaying the data, including an embedded microprocessor 106, and embedded control software. A rechargeable lithium battery pack 107 provides power to the device, and can be recharged from the solar panel 104 or the USB charger. In addition, a unique product registration number 108 can be included to uniquely identify the device, for purposes of product registration and user association in a user's profile.

Since the device will generally be mounted in a location that is not easily accessible by a driver, the digital bumper sticker 10 may include an accelerometer and/or timer mechanism 109. The accelerometer detects the motion of the vehicle and activates the display. If no movement is detected for some period of time, such as 20 minutes, then the digital bumper sticker 10 is automatically turned off.

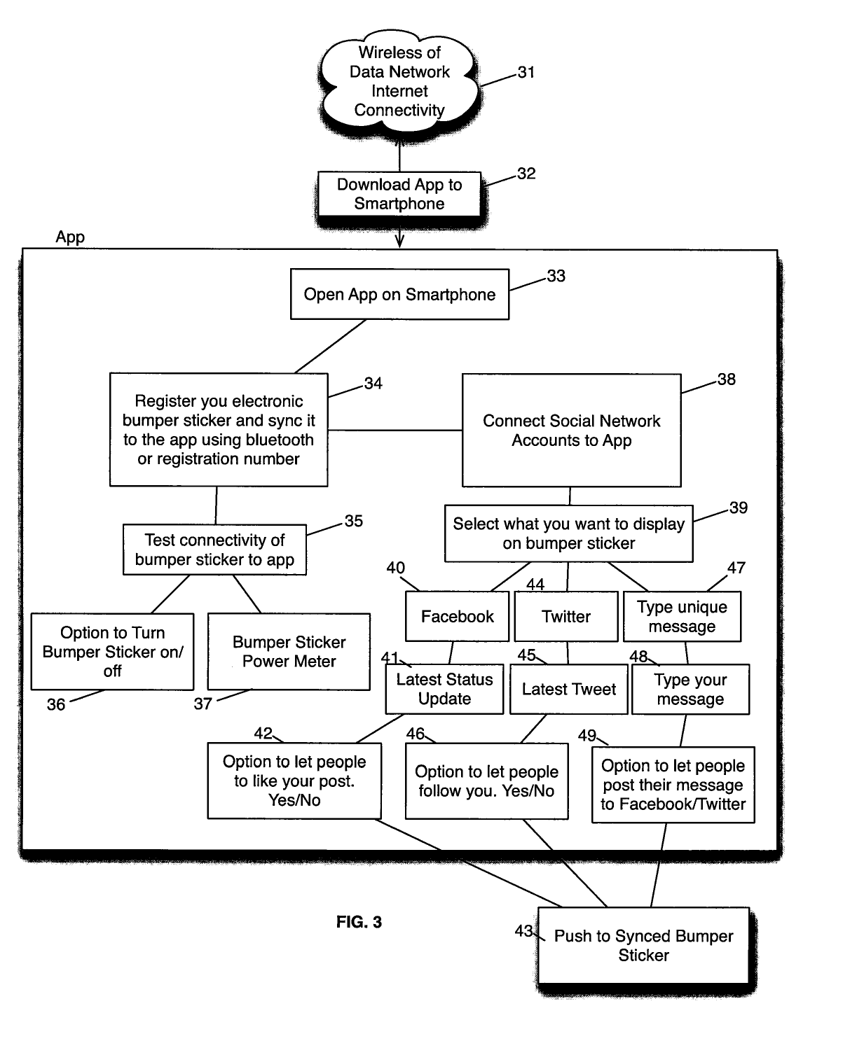

FIG. 3 is a flow diagram illustrating the set-up and operation of the digital bumper sticker 10. In a preferred embodiment, the portable electronic device 12 runs an application program that communicates with an application server. The portable electronic device 12 connects to a website, such as an “app store” to download the digital bumper sticker app (31). The app is then downloaded to the device (32). The user opens the app (33) and registers the digital bumper sticker and associates it using the registration number and/or unique identification number (34). The user may then test the connectivity to the bumper sticker using the Bluetooth functionality (35), and can control the bumper sticker (36) or check the battery level (37).

The user then associates desired social media or other content accounts to the app (38). The user the selects the content from one of the associates sites for display on the digital bumper sticker (39). For example, if the user selects Facebook™ (40), the user can have the latest “status update” displayed on the digital bumper sticker (41). The user can allow the public to “like” or otherwise comment on the displayed message (42), and the content is then pushed to the digital bumper sticker 10 with a sync process (43).

Similarly, a user can access a Twitter™ account (44), and select a recent “tweet” (45), and set an option to allow viewers to “follow” the Twitter™ account (46). Again, the content would then be synced to the digital bumper sticker (43). As another example, a user can simple choose to type a unique message (47) on the portable electronic device 12, and enter the text of the message of the portable electronic device 12 (48). The user could then select an option to allow viewers to post a comment about the text message on Facebook™, Twitter™ or other similar social media site (49). This content is similarly synced to the digital bumper sticker 10 (43). While the examples herein illustrate text being sent to the display, graphics or images may be selected and displayed as well.

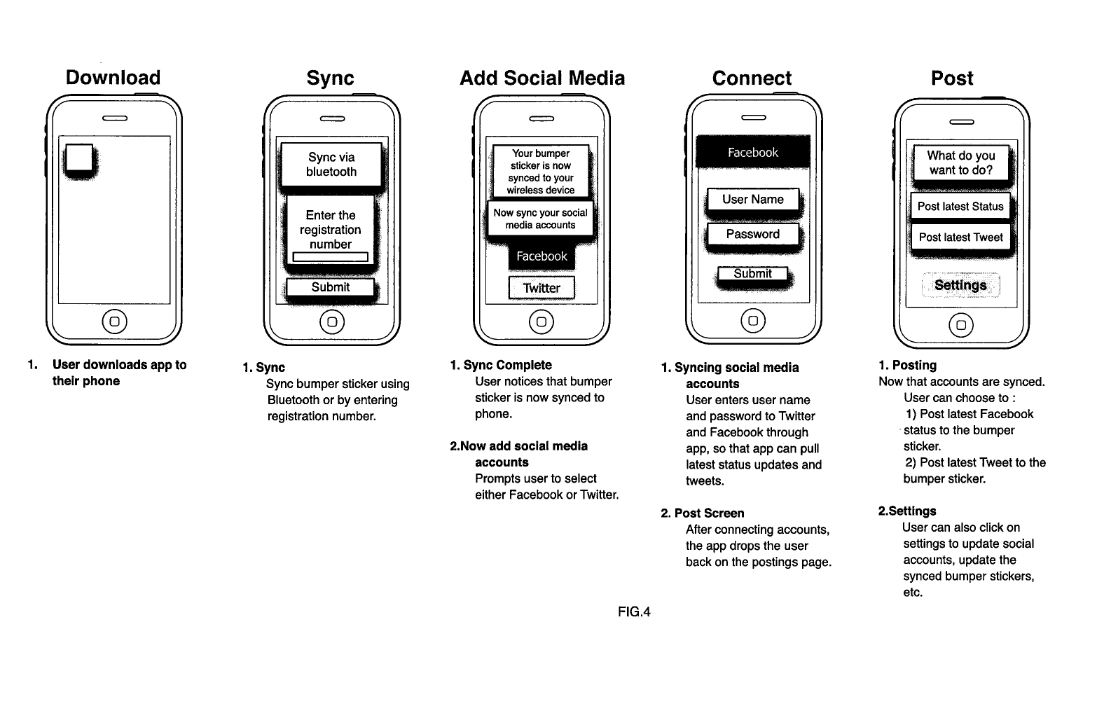

FIG. 4 illustrates a set of exemplary screens for downloading and configuring a smartphone app for use with the present invention. First, a user downloads the app to the smartphone (40). Then, the user syncs to the bumper sticker using Bluetooth wireless connectivity or by entering the registration number (41). Once the sync process is complete, the user can add social media accounts (42). The user then accesses a social media account in order for the app to “pull” content from the sites (43). Finally, the user can select the latest updates from a particular account, and the message will be displayed on the digital bumper sticker (44).

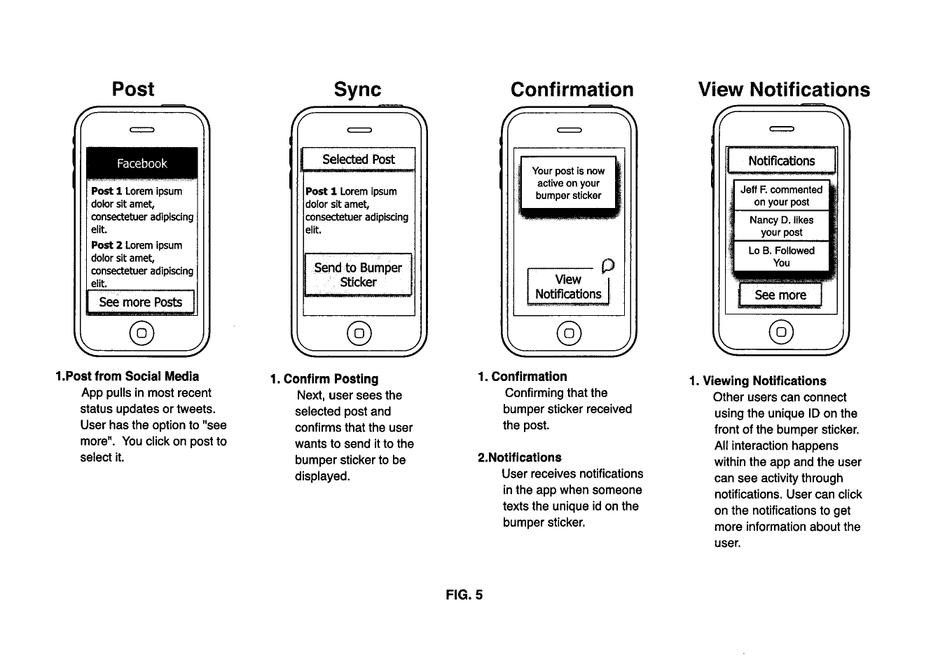

FIG. 5 illustrates an exemplary set of screens for posting messages and seeing notifications on a smartphone app for use with the present invention. The app can pull in most recent status updates or tweets from selected social media accounts (51). The use can select a message for display, and the message is synced to the digital bumper sticker (52). The app receives a confirmation that the digital bumper sticker received the post, and the app will notify the user when any notifications are received (52). The user can then review the notifications that have been posted in response to the message displayed on the digital bumper sticker (53).

Portions of the present invention may be conveniently implemented using a conventional general-purpose or a specialized digital computer or microprocessor programmed according to the teachings of the present disclosure, as will be apparent to those skilled in the computer art.

Appropriate software coding can readily be prepared by skilled programmers based on the teachings of the present disclosure, as will be apparent to those skilled in the software art. The invention may also be implemented by the preparation of application-specific integrated circuits or by interconnecting an appropriate network of conventional component circuits, as will be readily apparent to those skilled in the art based on the present disclosure.

The present invention includes a computer program product which is a storage medium (media) having instructions stored thereon/in which can be used to control, or cause, a computer to perform any of the processes of the present invention. The storage medium can include, but is not limited to, any type of disk including floppy disks, mini disks (MD's), optical discs, DVD, CD-ROMS, CD or DVD RW+/−, micro-drive, and magneto-optical disks, ROMs, RAMs, EPROMs, EEPROMs, DRAMs, VRAMs, flash memory devices (including flash cards, memory sticks), magnetic or optical cards, SIM cards, RAID devices, remote data storage/archive/warehousing, or any type of media or device suitable for storing instructions and/or data.

Stored on any one of the computer readable medium (media), the present invention includes software for controlling both the hardware of the general purpose/specialized computer or microprocessor, and for enabling the computer or microprocessor to interact with a human user or other mechanism utilizing the results of the present invention. Such software may include, but is not limited to, device drivers, operating systems, and user applications. Ultimately, such computer readable media further includes software for performing the present invention, as described above.

Included in the programming (software) of the general/specialized computer to or microprocessor are software modules for implementing the teachings of the present invention, and the display, storage, or communication of results according to the processes of the present invention.

Those skilled in the art will appreciate that various adaptations and modifications of the just described preferred embodiments can be configured without departing from the scope and spirit of the invention. Therefore, it is to be understood that, within the scope of the appended claims, the invention may be practiced other than as specifically described herein.

What is claimed is:

1. A system for displaying digital content, the system comprising:
an electronic display, the electronic display comprising:
a message display area;
a unique identification code; and
a data communications unit;
and a portable electronic device, the portable electronic device comprising:
at least one data communications unit; and
a software application to communicate with the electronic display, and to send messages to the electronic display.

2. The system of claim 1, wherein the data communications unit is a wireless communications unit.

3. The system of claim 2, wherein the electronic display further comprises an accelerometer and timer unit to activate the display when motion is detected and to turn off the display after a period of no detected motion.

4. The system of claim 3, wherein the electronic display further comprises a rechargeable battery.

5. The system of claim 4, wherein the electronic display further comprises a solar panel to recharge the rechargeable battery.

6. The system of claim 2, where in the display further comprises a unique registration number.

7. The system of claim 3, wherein the display is a liquid crystal display.

8. The system of claim 5, wherein the electronic display further includes at least two sticky tabs to adhere the display to a window.

9. The system of claim 6, wherein the portable electronic device and the electronic display are associated via the unique registration number.

10. The system of claim 9, wherein the portable electronic device is configured to send updates from social media accounts to the electronic display.

11. The system of claim 10, wherein messages may be sent to the user of the portable electronic device by use of the unique identification number displayed on the electronic display.

12. The system of claim 1, wherein the portable electronic device comprises a first data communications unit for accessing a data network, and a second communications unit for communicating with the electronic display unit.

13. The system of claim 1, wherein the data communications unit comprises a wireless communications unit to access a mobile wireless data network.

14. A method for displaying messages on a display, the method comprising:
associating a portable electronic device with an electronic display;
accessing data for display from a web site;
selecting data for display on the electronic display;
sending the data for display from the portable electronic device to the electronic display; and
displaying the data on the electronic display.

15. The method of claim 14, further comprising displaying a unique identification code on the display.

16. The method of claim 15, further comprising receiving notifications of messages sent to the unique identification code.

17. The method of claim 16, wherein associating the portable electronic device with the electronic display comprises using a unique registration number associated with the electronic display.

18. The method of claim 17, wherein accessing data for display from a web site comprises accessing a user's social media accounts.

19. The method of claim 18, wherein sending the data from the portable electronic device to the electronic display comprises sending the data using Bluetooth.

20. A software application for a portable electronic device to control an electronic display, the software application including processor executable code for:
associating the portable electronic device with the electronic display;
accessing data for display from a web site;
selecting data for display on the electronic display; and
sending the data for display from the portable electronic device to the electronic display.

21. The software application of claim 20, further comprising executable code for receiving notifications of messages sent to a unique identification code associated with the electronic display.
